(19) United States
(12) Patent Application Publication
(10) Pub. No.: US 2020/0011723 A1
(43) Pub. Date: Jan. 9, 2020

(54) FROST PROTECTION COVER FOR A WATER METER AND CORRESPONDING METHOD OF PROTECTION

(71) Applicant: PROTECTO, Aix En Provence (FR)

(72) Inventor: Mourad AMARA, Arles (FR)

(73) Assignee: PROTECTO, AIX EN PROVENCE (FR)

(21) Appl. No.: 16/572,065

(22) Filed: Sep. 16, 2019

Related U.S. Application Data
(63) Continuation of application No. PCT/FR2018/050630, filed on Mar. 15, 2018.

(30) Foreign Application Priority Data
Mar. 16, 2017 (FR) 17/70260

(51) Int. Cl. G01F 15/10

(52) U.S. Cl. CPC G01F 15/10

(57) ABSTRACT

A frost protection cover for a water meter generally includes four parts, each made from a thermal textile laminate and stitched together into a generally upside down “T” shape. The four parts include: a central portion in the shape of a closed tubular sleeve having an upper opening and a lower opening, the lower opening having cut-outs on the right and left side; two lower portions forming, on each side of the central portion, on the right and left side, extensions to the respective cut-outs, the two lower portions being shaped as open tubes that can be folded shut, and the lower portions being stitched to the central portion; and an upper portion mounted on the central portion and serving as a cover that can be opened or closed over the upper opening of the central portion.

### CROSS-REFERENCE TO RELATED APPLICATIONS

This application is a continuation of International Application No. PCT/FR2018/050630, filed on Mar. 15, 2018, which claims priority to and the benefit of FR 17/70260 filed on Mar. 16, 2017. The disclosures of the above applications are incorporated herein by reference.

### FIELD

The present disclosure relates to a device and method for protecting and insulating a water meter against frost, and more particularly to a frost protection cover for a water meter, and to a method for protecting a water meter against frost using such a cover. The present disclosure thus finds application in the protection and thermal insulation of water meters.

### BACKGROUND

The statements in this section merely provide background information related to the present disclosure and may not constitute prior art.

In a known manner, it is the responsibility of the user, tenant or owner, to protect a water meter from frost. In case of damage due to frost, the cost of its replacement remains the responsibility of the consumer.

All repairs or generally replacements of the water meter, whose damage would be mainly due to frost, are performed by the water utility at the expense of the subscriber, the responsibility of whom is to take the necessary precautions in order to avoid above-mentioned issues.

Most current water meters have a rounded shape with:

a top portion which is the most fragile with regard to frost, because this top portion integrates the counting mechanism with movable parts generally made of plastic to avoid oxidation, and a dial on the top to display the counting data; and

a bottom portion from which depart on two opposite sides called right side and left side, inlet and outlet ducts provided with threaded ends for respectively connecting the water inlet pipe and the water outlet pipe.

The protection and insulation against frost of water meters is traditionally carried out by different insulation and protection methods consisting in placing different insulating materials such as polystyrene sheets, plastic bags, towels, strips of glass wool around the water meter.

Yet, these insulating materials do not guarantee a fully satisfactory result against frost and furthermore these materials are not at all suitable for this context because they may in particular retain moisture, attract rodents and termites, and/or be conducive to mold. Moreover, the accessibility to the water meter and its dial requires the complete and often difficult removal of these different insulating materials.

It has thus been proposed by the document KR 2013 0092764 a first protection solution which is in the form of a quilted body which is flat and which can be disposed around a water meter and around the inlet and outlet tubes, and which is provided with self-gripping tapes to keep the quilted body tight around the water meter and the inlet and outlet ducts.

This quilted body comprises:

a lower strip intended to surround both a bottom portion of the meter and the inlet and outlet tubes, where this lower strip is provided with an orifice for the passage of the top portion of the meter; and

an upper strip intended to surround the top portion of the meter, where a tab is provided on one edge to cover the top of the meter, and where the upper strip is connected to the lower strip by a junction leg.

This quilted body is made in one piece by assembling and cutting two membranes, by making internal junction lines to form parallel flanges, by inserting a thermal insulation material between the two membranes and by making peripheral junction lines to close the quilted body.

When in place, the water meter has, on the one hand, its top portion (the most fragile portion) surrounded by the upper strip and, on the other hand, its bottom portion (portion from which depart the inlet and outlet ducts) surrounded by the lower strip. Thus, this quilted body has several thermal weaknesses:

a first thermal weakness around the top portion of the water meter, resulting from the peripheral clearance between the upper strip and the lower strip, once these two strips are closed on themselves, this peripheral clearance being defined by the two slots on either side of the junction leg, which helps leaving a gape around the top portion of the meter;

a second thermal weakness around the top portion of the water meter, at the level of the self-gripping tapes which keep the upper strip closed on itself;

a third thermal weakness at the level of the internal junction lines, between the flanges, because along these internal junction lines the two membranes are directly joined one on top of the other without interposition of thermal insulation material; and

a fourth thermal weakness at the level of the self-gripping tapes of the lower strip, because this lower strip surrounds both the bottom portion of the meter and the inlet and outlet ducts, but this bottom portion of the meter is wider than the ducts so that it is impossible to properly flatten the self-gripping tapes without having folds and clearances likely to let the cold pass.

A second solution is known from the document KR 2017 0000767 and it consists of a cover provided with three independent portions which are assembled on the meter by means of self-gripping tapes and which comprise a rear half-shell intended to surround a rear half of the water meter and the inlet and outlet ducts, a front half-shell intended to surround a front half of the water meter and the inlet and outlet ducts, and a lid intended to cover the meter and provided with self-gripping tapes allowing closing the lid on the two half-shells.

When in place, this cover has several thermal weaknesses:

a first thermal weakness around the water meter resulting from the clearance between the two half-shells; and

a second thermal weakness around the inlet and outlet ducts also resulting from the clearance between the two half-shells.

Furthermore, this cover is limited in its use because it is adapted and shaped for a specific type of water meter, not to mention that it is impractical to install because it is made into three independent portions.

A third solution is known from the document KR 2016 0047224 and it consists of an integral cover made into three portions, namely a rear half-shell intended to surround a rear half of the water meter and the inlet and outlet ducts, a front half-shell intended to surround a front half of the water meter and the inlet and outlet ducts, and a lid intended to cover the meter.

When in place, this cover presents several thermal weaknesses:

a first thermal weakness around the water meter resulting from the clearance between the two half-shells; and

a second thermal weakness around the inlet and outlet ducts also resulting from the clearance between the two half-shells.

Furthermore, this cover is limited in its use because it is adapted and shaped for a specific type of water meter.

### SUMMARY

The present disclosure provides a cover for protecting a water meter against frost, which is adapted to conform and effectively insulate the shape of the water meters (generally rounded shape) in order to protect them, insulate them thermally and thus preserve them from shocks but especially from frost.

The present disclosure further provides an improved protection and thermal insulation for the top portion of the water meter, which is the most fragile portion with its dial and its counting mechanism, which advantageously allows for a homogeneous and effective protection against frost.

Furthermore, the present disclosure enables check-up of the dial of the water meter without acting on the protection and the insulation of the water meter.

Further still, the present disclosure provides a cover which provides insulation and protection of the water meter up to the threaded ends of the respective inlet and outlet ducts of the meter.

To this end, the present disclosure provides a cover for protecting a water meter against frost, the cover comprising four portions each tailored from a thermal textile complex and sewed together to present an upside down “T” like general shape having:

a central portion shaped as a closed tubular sleeve having an upper opening and a lower opening, where the lower opening has indentations on the right and on the left;

two lower portions forming, on each side of the central portion on the right and on the left, extensions for the respective indentations, where these lower portions are shaped as open tubes which can be closed on themselves, and where these lower portions are sewed on the central portion; and

an upper portion mounted on the central portion and serving as a lid that can be opened or closed on the upper opening of the central portion.

Thus, such a cover is provided so that the user fits or slips the central portion of the cover around the meter, like a sock, for example from above, so that the central portion forms a closed sleeve which surrounds and conforms to the water meter.

This fitting of the central portion of the cover will be performed until the inlet and outlet ducts of the water meter are placed in the respective indentations, and thus these inlet and outlet ducts will protrude from the central portion. As a result, the two lower portions will be closed on themselves around the inlet and outlet ducts, and the upper portion will be closed on the upper opening.

It should be noted that, within the meaning of the present disclosure, the concept of “closed tubular sleeve” for the central portion is to oppose to the concept of “open tube” for the lower portions, in the sense that:

the central portion is closed over its height (and it cannot be opened unless it is cut or damaged) so as to have a tubular shape adapted to be fitted or slipped around the meter like a sock and to surround the rounded shape of the water meter; and

the lower portions are open over their lengths in order to be able to be placed around the inlet and outlet ducts once fitting of the central portion is completed, and then be able to wrap these water inlet and outlet ducts by being closed on themselves.

It is thus very clear, in the meaning of the present disclosure, that the central portion cannot be a flat strip provided over its height with temporary fastening means such as self-gripping tapes (therefore means having thermal weaknesses) and which would be placed around the meter, like a jacket, to be closed temporarily.

In the context of the present disclosure, the central portion is a sleeve closed over its height which is fitted around the meter, like a sock and not like a jacket. In other words, the central portion is closed permanently over its height, from its lower opening up to its upper opening.

This shaping of the central portion greatly improves the thermal insulation of the water meter, and in particular of its top portion which is the most fragile, because the definitive and prior closure of the central portion allows improving and homogenizing the insulation of the water meter all around its top portion.

It should also be noted that the upper portion forms a lid which opens at the top of the cover, thus enabling access to the different information of the dial of the water meter without having to completely remove the cover.

Moreover, the use of a thermal textile complex, which may be the same and be different for the four portions of the cover, contributes to the enhanced thermal insulation obtained thanks to such a cover.

A thermal textile complex, sometimes called thermal tissue complexing, is well known in the textile field and it conventionally includes a superposition of several thin textile layers generally used for the manufacture of thermal protective clothing, and in particular insulating liners.

A thermal textile complex thus forms a flexible and multilayer textile part, adapted to conform to the shape of the water meter and its inlet and outlet ducts, and it comprises at least several layers of thermal textiles, whether woven or non-woven textiles.

It should be noted that the compositions of the materials used for tailoring the cover are effectively suitable both in thermal and environmental terms.

Thus, thanks to its geometric shaping and the choice of its materials and its assembly, the cover according to the present disclosure is easy to install.

In addition, its shape allows tightly conforming to the shape of the water meter, which improves the insulation of the top portion of the water meter as well as of its bottom portion with its inlet and outlet ducts.

In addition, the cost of tailoring such a cover is low and therefore a mass industrialization is easily conceivable, so that individuals and communities can enjoy an affordable and especially effective cover.

Thus, according to one feature, the thermal textile complex comprises a superposition of several insulating textile layers.

According to another feature, the thermal textile complex comprises a superposition of at least four insulating textile layers, and in particular between four and nine insulating textile layers.

According to one variant, the thermal textile complex comprises at least one superposition of the following insulating textile layers:

a thin layer of reinforced polyethylene terephthalate (or reinforced PET);

a thin layer of wadding;

a thin layer of foam; and

a thin layer of polypropylene (such as BOPP, standing for “Biaxially Oriented Coextruded Polypropylene”).

According to one variant, the thermal textile complex comprises at least one superposition of the following insulating textile layers:

a thin layer of reinforced polyethylene terephthalate;

a thin layer of wadding;

a thin layer of foam;

a thin layer of polypropylene (such as BOPP);

a thin layer of foam;

a thin layer of polypropylene (such as BOPP);

a thin layer of wadding;

a thin layer of foam; and

a thin layer of reinforced polyethylene terephthalate.

In a particular form, the thermal textile complex comprises a waterproofing fabric covering the superposition of several insulating textile layers, thus providing a waterproofing function against water runoff.

According to one possibility, the waterproofing fabric is a PVC coated nonwoven fabric.

In a particular form, the upper portion is provided with a self-gripping tape associated with a complementary self-gripping tape provided on the central portion to keep the upper portion closed on the upper opening.

Thus, the upper portion, advantageously sewed in a reinforced manner on the top of the central portion, can be easily and quickly opened and closed by a self-gripping tape.

Advantageously, the central portion is provided with self-gripping tapes (e.g., hook and loop fasteners) allowing closing the lower opening.

Thus, the bottom of the central portion of the cover protrudes on the underside of the bottom portion of the water meter, and can be closed under the water meter (and more specifically under the bottom portion of the water meter) by means of these self-gripping tapes.

In other words, the bottom portion of the central portion of the cover is closed on itself using these self-gripping tapes and perfectly conform to the tube-shaped bottom of the water meter resulting in improved insulation and protection.

According to a possibility of the present disclosure, the lower portions are provided with self-gripping tapes to keep the lower portions closed on themselves.

Thus, these lower portions are closed on themselves using these self-gripping tapes in order to insulate and protect the inlet and outlet ducts of the water meter.

According to another possibility of the present disclosure, the lower portions are externally sewed on the sides of the central portion, in order to reduce thermal losses at the level of these seams.

In accordance with another advantageous feature of the present disclosure, the central portion is closed over its height from its lower opening up to its upper opening by sewing.

In a particular form, the central portion is closed by at least one internal seam along two flaps facing inwardly.

Alternatively, the central portion is closed by at least one external seam along two flaps facing outwardly.

According to another variant, the central portion is closed by at least one seam along two flaps which overlap across the thickness thereof.

Advantageously, the upper portion is provided with a peripheral folded edge adapted to cover the exterior of the central portion.

The use of such a folded edge is particularly advantageous for insulating from cold after a downward movement.

The present disclosure also relates to a protection method for protecting and insulating against frost a water meter, wherein the water meter has a top portion integrating a counting mechanism and a dial at the top, and a bottom portion from which depart, on two opposite sides, inlet and outlet ducts provided with threaded ends, the protection method being remarkable in that it includes using a cover according to the present disclosure by:

slipping the central portion around the water meter until the inlet and outlet ducts of the water meter are placed in the respective indentations of the central portion;

closing the two lower portions around the respective inlet and outlet ducts of the water meter; and

closing the upper portion on the upper opening of the central portion and on the dial of the water meter.

Such a protection method may advantageously implement at least one of the following steps, considered alone or in combination:

the two lower portions are closed on themselves and around the respective inlet and outlet ducts by means of self-gripping tapes;

the upper portion is closed on the upper opening of the central portion by means of self-gripping tapes;

the lower opening of the central portion is closed by means of self-gripping tapes under the bottom portion of the water meter; and/or

the two lower portions, respectively, cover the inlet and outlet ducts up to their respective threaded ends.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic perspective view of a cover in accordance with the present disclosure;

FIG. 2 is a schematic front view of the cover of FIG. 1 in place on a water meter;

FIG. 3 is a schematic back view of the cover of FIG. 1 in place on a water meter;

FIG. 4 is a schematic angled bottom and back view of the cover of FIG. 1 in place on a water meter, with the bottom of the central portion and lower portions opened;

FIG. 5 is a schematic angled bottom and back view of the cover of FIG. 1 in place on a water meter, with the bottom of the central portion closed and the lower portions opened;

FIG. 6 is a schematic top view of the cover of FIG. 1 in place on a water meter, with the upper portion forming a lid, which is open;

FIG. 7 is a schematic perspective view of the water meter without the cover;

FIG. 8 is a schematic angled bottom and back view of the cover of FIG. 1, with the bottom of the central portion and the lower portions opened;

FIG. 9 is a schematic front view of the cover of FIG. 1, with the bottom of the central portion the lower portions opened; and

FIG. 10 is a schematic angled side and back view of the cover of FIG. 1, with the bottom of the central portion and the lower portions opened.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

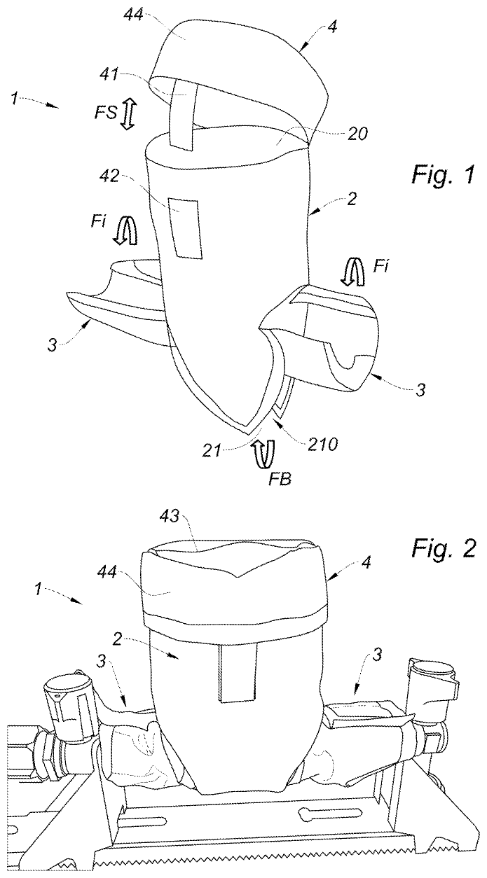

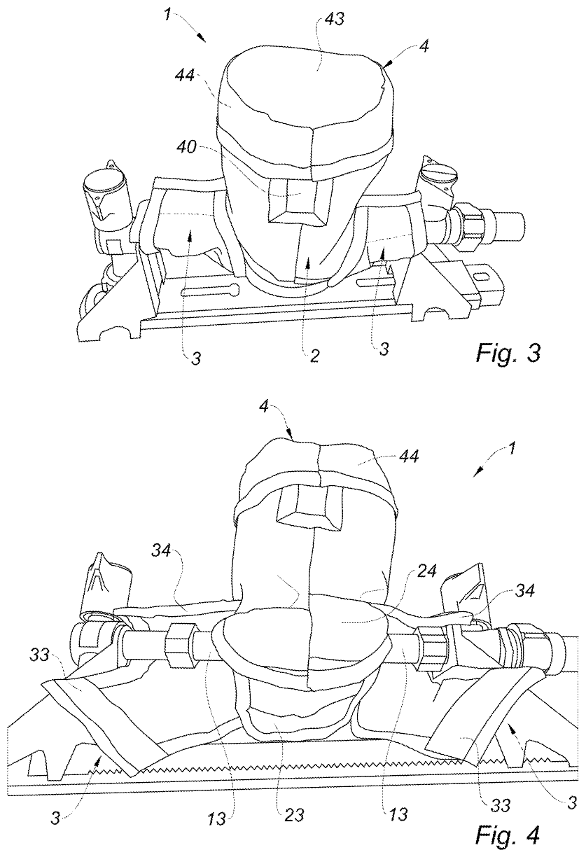

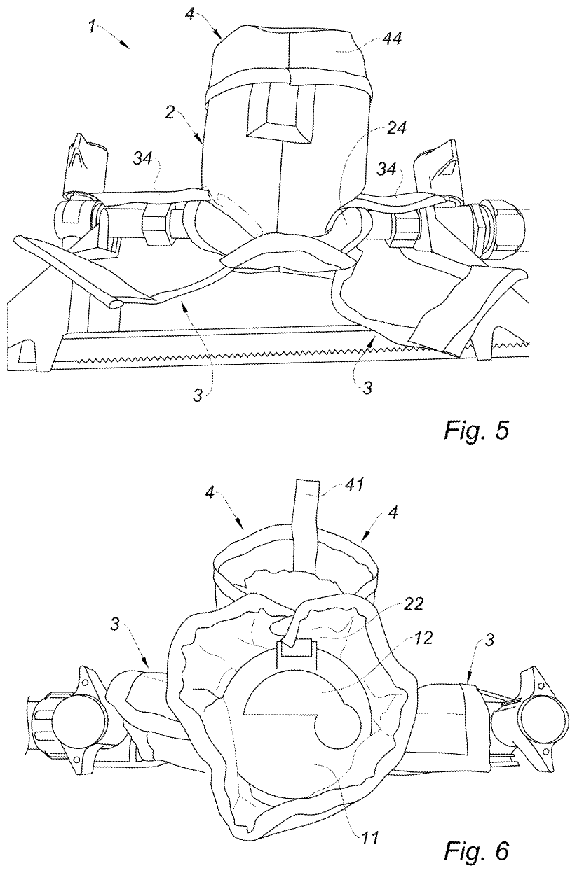

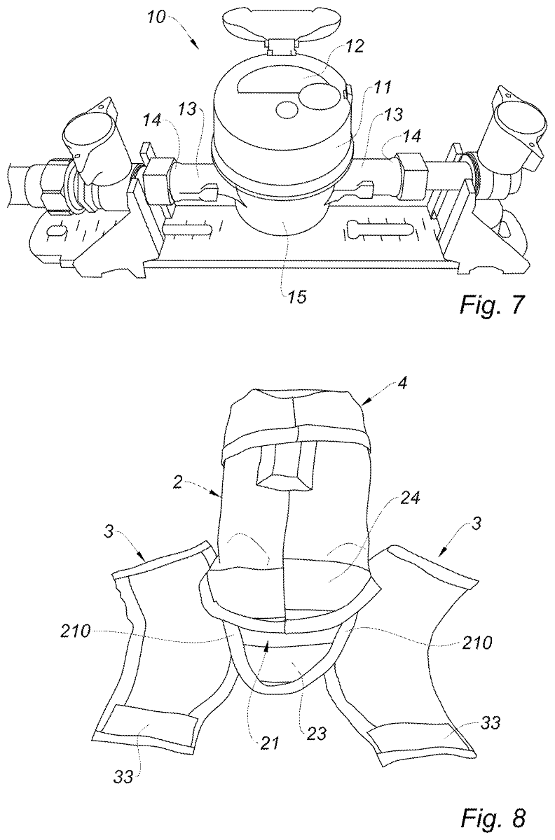

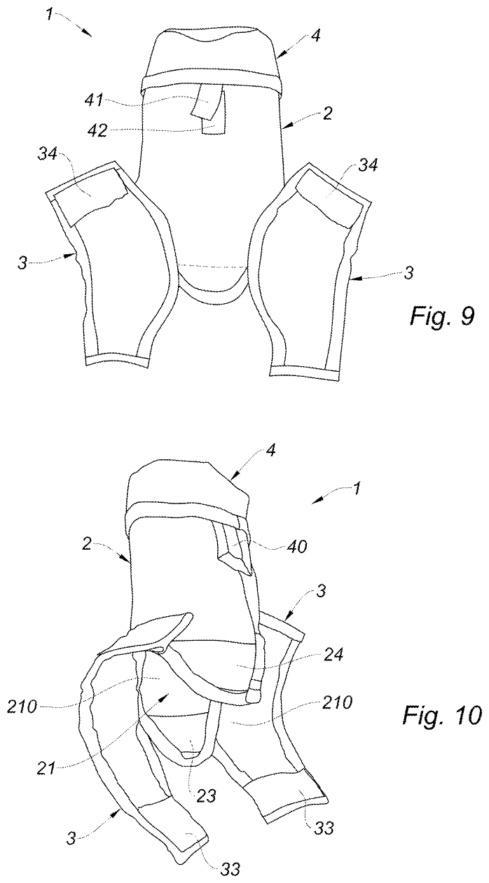

Referring to FIGS. 1 to 10, a cover 1 according to the present disclosure comprises a cover for protecting a water meter 10 (best shown in FIG. 7) against frost.

Such a water meter 10 includes:

a top portion 11 integrating an inner counting mechanism (not shown) and a dial 12 at the top; and

a bottom portion 15 from which depart on two opposite sides, inlet and outlet ducts 13 provided with threaded ends 14 to connect by screwing respectively a water inlet pipe and a water outlet pipe.

The cover 1 comprises four portions each tailored from a thermal textile complex and sewed together to have a general shape of an upside down “T.”

The thermal textile complex comprises a superposition of at least four insulating textile layers, and in particular between four and nine insulating textile layers, covered with a waterproofing fabric such as for example a PVC coated nonwoven fabric.

Thus, the thermal textile complex forms the internal liner of each portion of the cover 1 in order to confer protection and thermal insulation, and the waterproofing fabric forms the external membrane to confer waterproofing.

More specifically, the cover 1 comprises:

a central portion 2 shaped as a closed tubular sleeve having an upper opening 20 (on the top of the central portion 2) and a lower opening 21 (on the bottom of the central portion 2), where the lower opening 21 has indentations 210 on the right and on the left;

two lower portions 3 forming, on each side of the central portion 2 on the right and on the left, extensions for the respective indentations 210, where these lower portions 3 are shaped as open tubes which can be closed on themselves, and where these lower portions 3 are sewed on the central portion 2; and

an upper portion 4 mounted on the top of the central portion 2 and serving as a lid that can be opened or closed on the upper opening 20 of the central portion 2.

The upper portion 4 is attached to the central portion 2 by means of a tab 40 sewed both on the upper portion 4 and on the central portion 3; such a flexible tab authorizing the opening/closing of the upper portion 4.

The upper portion 4 is provided with a self-gripping tape 41 associated with a complementary self-gripping tape 42 provided on the central portion 2 to keep the upper portion 4 closed on the upper opening 20.

The upper portion 4 is provided with a disc 43 bordered by a peripheral folded edge 44 capable of covering the outside of the central portion 2 when this upper portion 4 is closed. This peripheral folded edge 44 overlapping the top of the central portion 2, this peripheral folded edge 44 may be formed only by the waterproofing fabric. On the contrary, the disc 43 is well formed by the thermal textile complex.

When in place, the upper portion 4 covers the top of the water meter 10, in other words covers its top portion 11 and its dial 12.

The central portion 2 is closed over its entire height, from its lower opening 21 to its upper opening 20, by sewing. As shown in FIG. 6, the central portion 2 is closed by at least one internal seam 22 along two flaps facing inwardly.

The central portion 2 has at the bottom of the complementary self-gripping tapes 23, 24, on either side of the indentations 210, allowing closing the lower opening 21, with more specifically an internal self-gripping tape 23 provided on an internal face of the central portion 2, and an external self-gripping tape 24 provided on an external face of the central portion 2 for closing by overlapping of this internal face on the external face.

The lower portions 3 are sewed on the outside on the sides of the central portion 2, along the indentations 210.

These lower portions 3 have complementary self-gripping tapes 33, 34 to keep the lower portions 3 closed on themselves, with more specifically for each lower portion 3 an internal self-gripping tape 33 provided on an internal face of the lower portion 3, and an external self-gripping tape 34 provided on an external face of the lower portion 3 for closing by overlapping of this internal face on the external face.

The protection method for protecting and insulating the water meter 10 against frost by means of such a cover 1 implements the following steps of:

slipping (or fitting) the central portion 2 around the water meter 10 until the inlet and outlet ducts 13 of the water meter 10 are placed in the respective indentations 210 of the central portion 2;

closing the two lower portions 3 around the respective inlet and outlet ducts 13 of the water meter 10 by means of the self-gripping tapes 33, 34, where these lower portions 3 thus respectively cover the inlet and outlet ducts 13 up to their respective threaded ends 14 (as schematized by the arrows F1 in FIG. 1);

closing the upper portion 4 of the upper opening 20 of the central portion 2 and the dial 12 of the water meter 10 by means of the self-gripping tapes 41, 42 (as schematized by the arrows FS in FIG. 1); and

closing the lower opening 21 of the central portion 2 (in other words closing the bottom of the central portion 2) by means of the self-gripping tapes 23, 24 under the bottom portion 15 of the water meter 10 (as schematized by the arrow FB in FIG. 1).

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice; material, manufacturing, and assembly tolerances; and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A cover for protecting a water meter, the cover comprising:
a central portion defining a closed tubular sleeve-shape and having an upper opening and a lower opening, wherein the lower opening includes indentations on a right and a left side of the central portion;
two lower portions, each lower portion forming an extension for the respective indentations and shaped as an open tube which can be closed on itself, wherein the two lower portions are sewn to the central portion; and
an upper portion mounted on the central portion and forming a lid that can be opened and closed on the upper opening of the central portion,
wherein the central portion, the two lower portions, and the upper portion are made from a thermal textile complex and define an upside down T shape.

2. The cover according to claim 1, wherein the thermal textile complex comprises a superposition of a plurality of insulating textile layers.

3. The cover according to claim 2, wherein the thermal textile complex comprises a superposition of at least four insulating textile layers.

4. The cover according to claim 2, wherein the thermal textile complex comprises a waterproofing fabric covering the superposition of several insulating textile layers.

5. The cover according to claim 4, wherein the waterproofing fabric is a PVC coated nonwoven fabric.

6. The cover according to claim 1, wherein the upper portion includes a self-gripping tape and a complementary self-gripping tape on the central portion to keep the upper portion closed on the upper opening.

7. The cover according to claim 1, wherein the central portion includes self-gripping tapes for closing the lower opening.

8. The cover according to claim 1, wherein the two lower portions include self-gripping tapes to keep the lower portions closed on themselves.

9. The cover according to claim 1, wherein the lower portions are externally sewn to the sides of the central portion along the indentations.

10. The cover according to claim 1, wherein the central portion is closed over a height from the lower opening to the upper opening by sewing.

11. The cover according to claim 10, wherein the central portion is closed by at least one internal seam along two flaps facing inwardly.

12. The cover according to claim 1, wherein the upper portion includes a peripheral folded edge capable of covering an exterior of the central portion.

13. A method for protecting and insulating a water meter having a top portion integrating a counting mechanism and a dial at a top, and a bottom portion from which depart, on two opposite sides, inlet and outlet ducts having threaded ends, the method comprising:
providing a cover according to claim 1;
slipping the central portion around the water meter until the inlet and outlet ducts of the water meter are placed in their respective indentations of the central portion;
closing the two lower portions around the respective inlet and outlet ducts of the water meter; and
closing the upper portion on the upper opening of the central portion and on the dial of the water meter.

14. The protection method according to claim 13, wherein the two lower portions are closed on themselves and around the respective inlet and outlet ducts of the water meter by self-gripping tapes.

15. The protection method according to claim 13, wherein the upper portion is closed on the upper opening of the central portion by self-gripping tapes.

16. The protection method according to claim 13, wherein the lower opening of the central portion is closed by self-gripping tapes under the bottom portion of the water meter.

17. The protection method according to claim 13, wherein the two lower portions respectively cover the inlet and outlet ducts up to their respective threaded ends.
